(19) United States
(12) Patent Application Publication
(10) Pub. No.: US 2021/0215276 A1
(43) Pub. Date: Jul. 15, 2021

(54) MOLDING TO CONTROL HOSE ROUTING AND SYSTEMS AND METHODS THEREOF

(71) Applicant: Caterpillar Inc., Peoria, IL (US)

(72) Inventor: Bradley D. Smith, Stephenson, MI (US)

(73) Assignee: Caterpillar Inc., Peoria, IL (US)

(21) Appl. No.: 16/740,675

(22) Filed: Jan. 13, 2020

(51) Int. Cl. F16L 3/123; F16L 3/18; E02F 9/22

(52) U.S. Cl. CPC F16L 3/1236; E02F 9/2275; F16L 3/18

(57) ABSTRACT

A one-piece exterior molding for controlling routing of an underlying hose can comprise a plurality of rings that extend in spaced relationship in a length direction of the exterior molding, and at least two spannings that run in the length direction of the exterior molding from a first end portion of the exterior molding to a second end portion of the exterior molding opposite the first end portion. The at least two spannings can be spaced from each other radially, according to different radii extending from a central axis of the exterior molding. The exterior molding is configured to control routing of the underlying hose according to straight and/or one or more curves based on configuration of the plurality of rings and the at least two spannings.

### TECHNICAL FIELD

The present disclosure relates to one or more moldings to control hose routing and systems and methods thereof.

### BACKGROUND

A hose, such as a hydraulic hose of a work machine, may be routed by clipping points and by natural bends of the hose between hose couplings. Such routing may limit available options for routing the hose and may lead to conditions which reduce reliability and durability of hose assemblies.

U.S. Pat. No. 10,107,431 (“the '431 patent”) describes a flexible hose guard in the form of an anti-kinking device. The anti-kinking device has a neck portion with a threaded internal surface, and a mesh pattern portion connecting the neck portion and a terminal portion. The mesh pattern portion has a central axis and a plurality of equally configured rectangular open spaces between each mesh pattern in a relaxed state. According to the '431 patent, a hose is inserted through the anti-kinking device. However, the '431 patent is not understood to describe, for instance, that the anti-kinking device has an interior surface that is fixedly attached (e.g., overmolded) to the underlying hose.

### SUMMARY OF THE DISCLOSURE

In one aspect, the present disclosure provides or implements a one-piece exterior molding for controlling routing of an underlying hose comprising. The one-piece exterior molding can comprise a plurality of rings that extend in spaced relationship in a length direction of the exterior molding from a first end of the exterior molding to a second end of the exterior molding opposite the first end; and at least two spannings each running in the length direction of the exterior molding from a first end portion of the exterior molding to a second end portion of the exterior molding opposite the first end portion, each of the at least two spannings being made up of a plurality of spanning portions between adjacent rings of the plurality of rings. The at least two spannings are spaced from each other radially, according to different radii extending from a central axis of the exterior molding, and the exterior molding is configured to control routing of the underlying hose according to straight and/or one or more curves based on configuration of the plurality of rings and the at least two spannings.

In another aspect, a hydraulic hose assembly for a working machine can be provided or implemented. The hydraulic hose assembly can comprise a hydraulic hose having a first length and a circular cross-section; and a one-piece exterior molding having a second length less than the first length, the exterior molding being fixedly molded around an entire circumference of the hydraulic hose in spaced relation from opposing ends of the hydraulic hose. The exterior molding can include a contiguous plurality of different hose control sections, where each said hose control section can have a plurality of spaced-apart rings that extend in a length direction of the exterior molding, the plurality of rings including a first end ring and a second end ring at opposing ends of the hose control section and at least one middle ring between the first and second end rings, and at least two spannings each running continuously from the first end ring to the second end ring of the hose control section. The at least two spannings are spaced from each other radially, according to different radii extending from a central axis of the exterior molding, and the hose control sections are configured to restrict movement and/or bend of respective underlying portions of the hydraulic hose according to one or more predefined directions based on configuration of the plurality of rings and the at least two spannings.

And in another aspect, a method can be implemented, the method comprising providing a hose having a first length; and providing a one-piece exterior molding having a second length less than the first length, wherein the exterior molding can include a plurality of spaced-apart rings that extend along the second length of the exterior molding, and at least two spannings each running continuously from a first end portion of the exterior molding to a second end portion of the exterior molding opposite the first end portion. The at least two spannings are spaced from each other radially, according to different radii extending from a central axis of the exterior molding, and the exterior molding is configured to control routing of the hose according to straight and/or one or more predefined curves based on configuration of the rings and the at least two spannings.

Other features and aspects of this disclosure will be apparent from the following description and the accompanying drawings.

### BRIEF DESCRIPTION OF THE DRAWINGS

FIG. 1 illustrates a side view of a machine according to embodiments of the disclosed subject matter.

FIG. 2 illustrates a hose assembly according to embodiments of the disclosed subject matter.

FIG. 3 illustrates another hose assembly according to embodiments of the disclosed subject matter.

FIG. 4 is a sectional view of an exterior molding of the hose assembly of FIG. 3.

FIG. 5 is a sectional view of a portion of the exterior molding of FIG. 4.

FIG. 6 is a sectional view of a portion of the exterior molding of FIG. 4.

### DETAILED DESCRIPTION

The present disclosure relates to one or more moldings to control hose routing and systems and methods thereof.

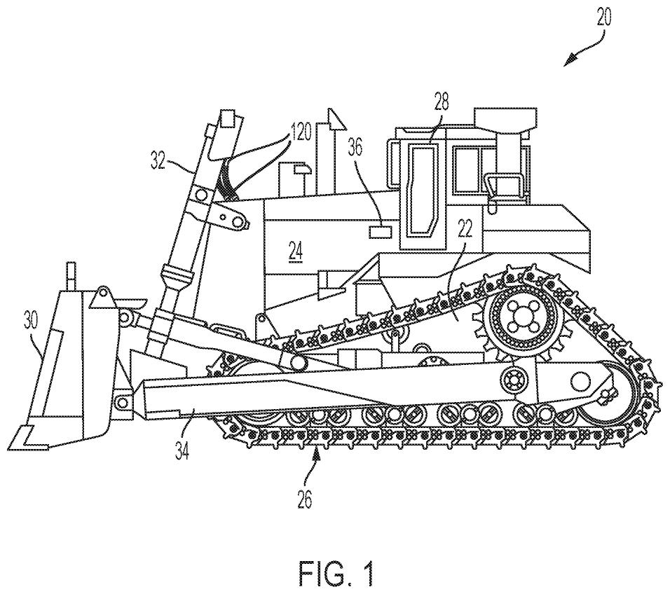

Referring now to the drawings, FIG. 1 illustrates a side view of a machine 20 according to embodiments of the disclosed subject matter. While the machine 20 is depicted as a track-type tractor, it is to be understood that the teachings of the present disclosure can be used with equal efficacy in connection with any other number of working machines, whether stationary or mobile, including earth-moving machines (e.g., loaders, motor graders, pipe layers, skid steers, and the like), construction machines, agricultural machines, mining machines, marine machines, off-highway machines, and on-high machines, as non-limiting examples.

With respect to the machine 20, it is shown (diagrammatically) to include a chassis 22 on which is mounted an engine 24. The chassis 22 can also support an operator cabin 28. The machine 20 can further include first and second tracks 26 laterally flanking the machine 20, although in other embodiments the form of locomotion may be provided in alternative formats such as, but not limited to, wheels.

As also illustrated in FIG. 1, the machine 20 may include one or more implements 30 provided to perform work. The implement 30 depicted in FIG. 1 is a blade, but other implements are possible. The implement 30 is movable relative to the machine 20 by way of one or more hydraulic cylinders 32 and boom arms 34. The hydraulic cylinders 32 are in fluid communication with a hydraulic fluid pump 36 by way of a plurality of hydraulic fluid conduits 120. The pump 36, in turn, can be powered by the engine 24.

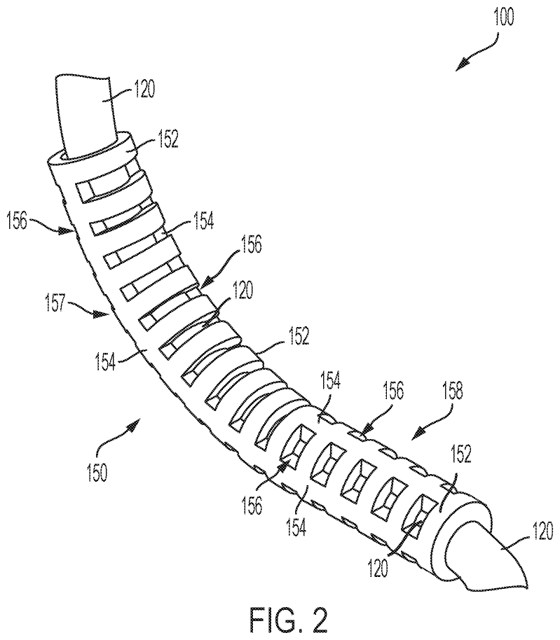

Turning to FIG. 2, FIG. 2 illustrates a hose assembly 100 according to embodiments of the disclosed subject matter. The hose assembly 100 can be comprised of the hydraulic fluid conduit 120 and an exterior molding 150.

The hydraulic fluid conduit 120 can be in the form of a hose configured to fluidly pass hydraulic fluid therethrough between opposite ends thereof and corresponding hydraulic connections associated with the hydraulic cylinders 32. The hydraulic fluid conduit 120, which will be hereinafter referred to as a hose 120, can be made of elastomers, fluoropolymers and silicone, thermoplastics, metal, and composite or laminated structures. According to one or more embodiments of the disclosed subject matter, the hose 120 may be cylindrical, with a circular cross-section, though embodiments of the disclosed subject matter are not limited to cylindrical hoses and may include other geometries, such as flat hoses or hoses with an oval cross-section.

Additionally, though hose 120 is described above as a hydraulic hose, embodiments of the disclosed subject matter are not limited to hydraulic hoses, and may include other types of hoses, such as pneumatic hoses, dynamic or static, where dynamic can mean one or more of the hose connections (and hence the hose) moves with a moving component of a corresponding machine (e.g., during articulation) and static can mean that neither of the hose connections move with movement of the machine, though in both cases the hose may move (or try to move) based on a substance passing therethrough, such as hydraulic fluid or air.

The exterior molding 150, according to embodiments of the disclosed subject matter, can be in the form of a tubular body, formed as one-piece, meaning that the exterior molding 150 can be integral and a single unit, though a single exterior molding 150 can have one or more hose control sections (discussed in more detail below), and though a single hose 120 can have multiple separate one-piece exterior moldings 150. According to one or more embodiments, the exterior molding 150 can be made of an elastomer (e.g., rubber or urethane). Moreover, the exterior molding 150 may be made from a different material as compared to the hose 120.

The exterior molding 150 can be provided around the hose 120, particularly an outside cover of the hose 120. As shown in FIG. 2, for instance, the exterior molding 150 may be provided around an entire circumference of the hose 120. The exterior molding 150 can be fixedly attached or coupled to the hose 120. For example, the exterior molding 150 may be overmolded to the hose 120 using a die/mold and according to a molding process. Fixedly attached or coupled can mean, in one or more embodiments, that the exterior molding 150 cannot be removed from the hose 120 without destroying the exterior molding 150.

A geometrical shape of the exterior molding 150 can generally conform to a geometrical shape of the hose 120. For example, both may be cylindrical with circular cross-sections. Thus, in one or more embodiments, the hose 120 may have a maximum outer diameter that is uniform along the length of the hose 120. Likewise, the exterior molding 150 can have a maximum outer diameter that is uniform along the length of the exterior molding 150. However, according to one or more embodiments, as shown in FIG. 2, for instance, the exterior molding 150 may have a length less than a length of the hose 120. Thus, one or both ends of the exterior molding 150 can be spaced from corresponding opposite ends of the hose 120.

The exterior molding 150 can be comprised of a plurality of rings 152 and a plurality of spannings 154. The plurality of rings 152 can include at least opposite end rings and at least one ring between the end rings (FIG. 2 labels only the end rings and one ring between the end rings). The rings 152 can be spaced apart from each other in a length direction of the exterior molding 150, by the spannings 154 or, viewed differently, separate spanning portions between adjacent rings 152. According to one or more embodiments, the rings 152 may have a uniform thickness along the length of the exterior molding 150. Additionally or optionally, the spannings 154 (or spanning portions) can have a uniform thickness.

Depending upon the configuration of the exterior molding 150, according to one or more embodiments, at least one spanning 154 may run (e.g., continuously) from a first end portion of the exterior molding 150 to a second end portion of the exterior molding 150 opposite the first end portion. Thus, on one hand the spannings 154 can be considered as part of the rings 152 and vice versa. Viewed another way, each spanning 154 may be considered to be comprised of a plurality of spanning portions separated by adjacent rings 152, though still running along the length of the exterior molding 150. As such, optionally, each of the spannings 154 (including spanning portions) may be considered to end at opposite end rings 152 of the exterior molding 150.

According to one or more embodiments, the exterior molding 150 has only two spannings 154 (i.e., consists of two spannings 154). Alternatively, the exterior molding 150 has only four spannings 154 (i.e., consists of four spannings 154). Discussed in more detail below, embodiments of the disclosed subject matter may have different hose control sections with different numbers of spannings 154 per hose control section. For example, one hose control section may have only four spannings 154 and another hose control section may have only two spannings 154.

The spannings 154 can be spaced from each other. For example, as shown in FIG. 2, the spannings 154 can be spaced from each other radially, according to different radii extending from a central axis of the exterior molding 150. According to one or more embodiments, the radial spacing of the spannings 154 can be by a factor of 90 degrees. For example, in the case of only two spannings 154, the spannings 154 may be radially spaced from each other by 180 degrees. As another example, in the case of only four spannings 154, the radial spacing of the spannings 154 can be 90 degrees for all spannings 154.

The spacing between the rings 152 can create openings 156, which can extend entirely through a body of the exterior molding 150, from an outer surface of the exterior molding 150 to an inner surface of the exterior molding 150. Thus, portions of the hose 120 may be visible through the openings 156.

Depending upon the control configuration of the exterior molding 150, some or all of the openings 156 may be uniform, that is, have at least the same geometrical configuration. Additionally, in a case where the exterior molding has multiple hose control sections, the openings 156 per hose control section may be uniform. Alternatively, the openings 156 per hose control section may be substantially uniform in configuration, meaning, for instance, that due to curvature of the particular hose control section of the exterior molding 150 the geometry of the openings 156 is slightly different. For instance, relatively straight parts of a hose control section may have openings that are wider, at least in some areas, as compared to more curved portions of the hose control section on a same side of the exterior molding 150. As another example, openings 156 on an outside of a curve may be wider than openings 156 on an inside of the curve. Such variation may still make it possible to characterize the rings 152 as being uniformly spaced, at least at the juncture with the spannings 154 (or spanning portions).

Regarding hose control sections, embodiments of the disclosed subject matter can have only one or multiple hose control sections, at least one, some, or all of which may be different in configuration. Additionally, the hose control sections may be contiguous, meaning that one hose control section can lead directly to another, adjacent hose control section.

FIG. 2, for instance, shows two hose control sections, hose control section 157 and hose control section 158. Hose control section 157 may be characterized as a curved hose control section for providing curved control or restriction on the hose 120, and hose control section 158 may be characterized as a straight hose control section for providing straight control or restriction on the hose 120. Optionally, the hose control sections may be different in length. For example, as shown in FIG. 2, hose control section 157 is longer than hose control section 158. In this regard, it is noted that the hose control sections 157, 158 may be considered as sharing one of the rings 152 as an end ring thereof.

As shown, hose control section 157 can have two spannings 154, and hose control section 158 can have four spannings 154. The two spannings 154 for hose control section 157 can be radially spaced from each other, in this example spaced by 180 degrees. Likewise, the four spannings for hose control section 158 can be radially spaced from each other, in this example by 90 degrees.

In that hose control section 157 can have two spannings 154 and hose control section 158 can have four spannings 154, the openings 156 of the hose control section 157 can be different as compared to the openings 156 of the hose control section 158. Optionally, the openings 156 of the hose control section 157, which may be referred to as a first set of openings 156, and/or the openings 156 of the hose control section 158, which may be referred to as a second set of openings 156, can be uniform or substantially uniform in configuration. Substantially uniform in configuration may mean that the openings 156, at the very least, have a same width or thickness at interfaces with corresponding spannings 154, but may vary at other areas due to the curvature of the exterior molding 150.

Though exterior molding 150 in FIG. 2 can include two hose control sections, hose control section 157 (curved control) and hose control section 158 (straight control), embodiments of the disclosed subject matter are neither limited to only two hose control sections nor to the specific hose control sections 157, 158 shown in FIG. 2. For example, embodiments of the disclosed subject matter can have only one hose control section, hose control section 157, hose control section 158, or another hose control section, such as hose control section 157 rotated 180 degrees. Alternate combinations can also be provided, including multiple hose control sections 157 (i.e., longer), multiple hose control sections 158 (i.e., longer), or either hose control section 157 or hose control section 158 with another hose control section, such as hose control section 157 rotated by 180 degrees.

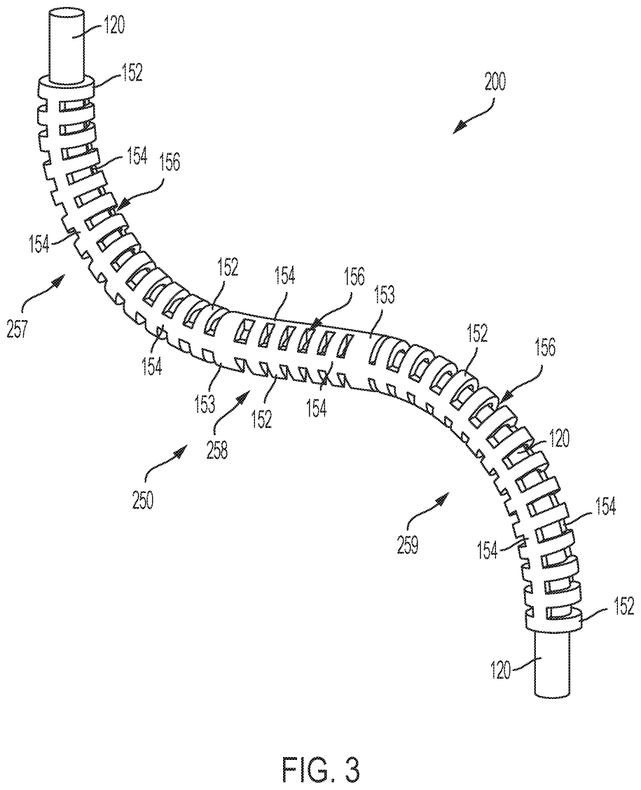

As another specific (but non-limiting) example, FIG. 3 illustrates another hose assembly 200 according to embodiments of the disclosed subject matter.

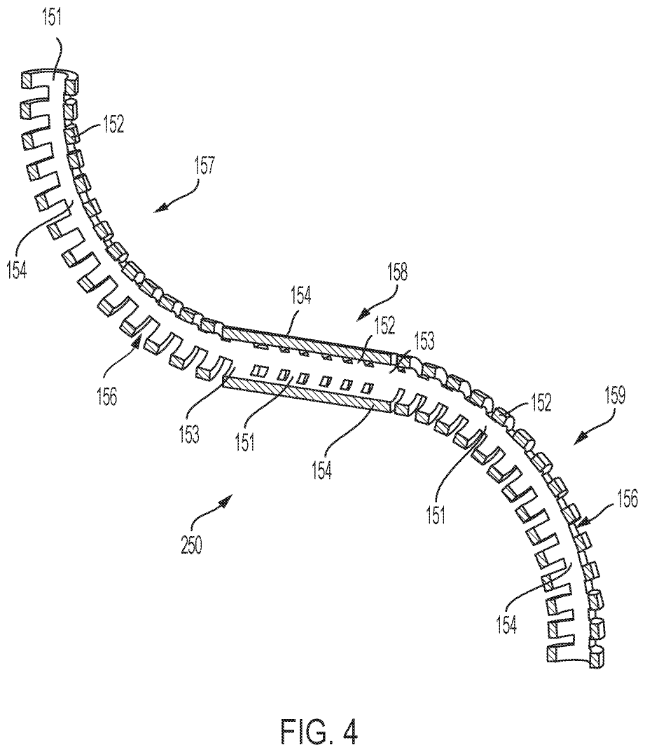

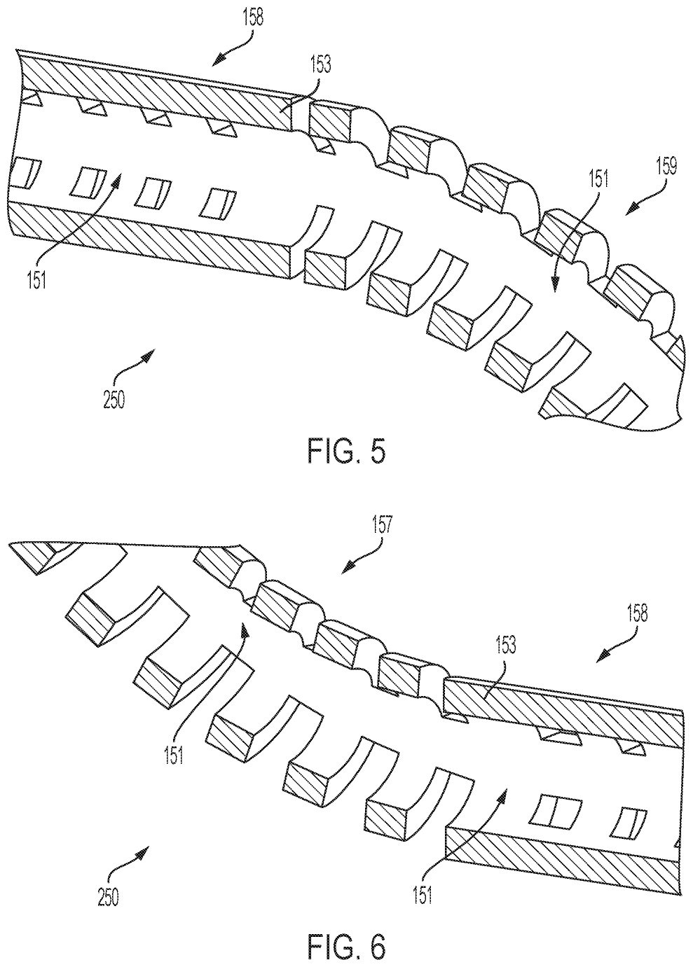

The hose assembly 200 according to FIG. 3 can have the hose 120 (or a variation thereof) and an exterior molding 250. FIGS. 4-6 show various sectional views of the exterior molding 250.

Exterior molding 250 can include three hose control sections, hose control section 257, hose control section 258, and hose control section 259. Hose control section 257 and hose control section 259 are similar to hose control section 157 above, and each may be characterized as a curved hose control section for providing curved control or restriction on the hose 120. Likewise, hose control section 258 is similar to hose control section 158 above, and may be characterized as a straight hose control section for providing straight control or restriction on the hose 120 (noting that the bottom spanning 154 is not shown from the view of FIG. 3).

Optionally, exterior molding 250 can have relatively more thick rings 153 between adjacent hose control sections. For instance, FIG. 3 shows a thick ring 153 between hose control section 258 and hose control section 257 and a thick ring 153 between hose control section 258 and hose control section 259. The thick ring 153 may be considered a shared ring by the adjacent hose control sections, or the thick ring 153 may be considered two rings 152 without spacing, respectively associated with the adjacent hose control sections.

Turning now to the sectional views of the exterior molding 250 in FIGS. 4-6, these views show that the exterior molding 250 can have an inner wall 151 that defines an inner volume of the exterior molding 250 (and the same can be true for exterior moldings according to embodiments of the disclosed subject matter, including exterior molding 150). As noted above, the inner wall 151, which can be opposite an outer wall of the exterior molding 250, can correspond to outer area portions of the hose 120. Optionally, the inner wall 151 may be smooth, without grooves or threadings, for instance, for a close-fit fixed coupling or attachment (e.g., via overmolding) to the outer surface of the hose 120.

### INDUSTRIAL APPLICABILITY

As noted above, the present disclosure relates to one or more moldings to control hose routing and systems and methods thereof.

Exterior moldings, such as exterior moldings 150, 250 discussed above, can be fixedly attached to an external surface (e.g., outside cover) of a hose, such as hose 120. According to embodiments of the disclosed subject matter, the exterior molding can be overmolded to the hose using a die/mold and molding process. Optionally, both the hose and the exterior molding can be provided or made (i.e., molded) at the same time to produce a resultant hose assembly comprised of only or at least the hose and the exterior molding.

Generally speaking, exterior moldings according to embodiments of the disclosed subject matter can be provided around the external surface of the hose to control or change the bend path of the hydraulic hose, for instance, during articulation (of a moving element of a working machine) or for static routing. The particular configuration of the exterior molding (or configurations in the case of multiple hose control sections) can determine the restriction or restrictions placed on the hose, particularly bend characteristics of the hose. More specifically, exterior moldings according to embodiments of the disclosed subject matter can have a series of rings and spannings, such as rings 152 and spannings 154 discussed above, to control physical arrangement of the hose 120. Particular arrangement of the spannings 154 can restrict movement and/or bend of the hose 120 to predefined directions. According to one or more embodiments, a hose may have a particular arrangement without the exterior molding (e.g., slight curve) and may have a different arrangement when the exterior molding is fixedly provided around the external surface of the hose (e.g., straight).

Generally, for a straight section of the hose, i.e., to keep a section of the hose straight and without or substantially without curvature, embodiments of the disclosed subject matter can implement four spannings 154, for instance, positioned at locations 90 degrees around the circumference of the rings 152 (put another way, spaced from each other radially, according to different radii extending from a central axis of the exterior molding 150, 250). And for a curved section of the hose, i.e., to keep a section of the hose from bending according to an undesirable bend, embodiments of the disclosed subject matter can implement two spannings 154, for instance, positioned at locations 180 around the circumference of the rings 152 (put another way, spaced from each other radially, according to different radii extending from a central axis of the exterior molding 150, 250).

For example, as noted above, the exterior molding 150 of FIG. 2 can include two hose control sections, hose control section 157 and hose control section 158. Hose control section 157 can have two spannings 154 offset from each other by 180 degrees. Such configuration of spannings 154 can allow for curvature or bending (e.g., according to a 90 degree bend) in the x-plane but can prevent or disallow for curvature or bending in the y-plane. Hose control section 158 can have four spannings 154 offset from each other by 90 degrees. Such configuration of spannings 154 can prevent or disallow for curvature or bending in the x- and y-planes and allow straight extension of the exterior molding 150 and underlying portion of the hose 120 in the z-plane.

FIG. 3 shows another example where exterior molding 250 has three hose control sections, hose control section 157, hose control section 158, and hose control section 159. Hose control section 157 and hose control section 159 each can have two spannings 154, for instance, offset from each other by 180 degrees. Such configuration of spannings 154 can allow for curvature or bending (e.g., according to a 90 degree bend) in the x-plane but can prevent or disallow for curvature or bending in the y-plane. Hose control section 158 can have four spannings 154, for instance, offset from each other by 90 degrees. Such configuration of spannings 154 can prevent or disallow for curvature or bending in the x- and y-planes and allow straight extension of the exterior molding 150 and underlying portion of the hose 120 in the z-plane.

Of course, embodiments of the disclosed subject matter can implement a hose control section with only two spannings 154 offset from each other by 180 degrees but rotated by 90 degrees relative to the configurations of hose control section 157 (and hose control section 159) to prevent curvature or bending in the x-plane. Furthermore, geometrical arrangement of hose assemblies according to embodiments of the disclosed subject matter, such as hose assemblies 100, 200, can be based not only on the configuration of the exterior molding 150, 250 but also the physical locations of the connection interfaces for the opposite ends of the hose 120.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A hydraulic hose assembly for a working machine comprising:
a hydraulic hose having a first length and a circular cross-section; and
a one-piece exterior molding having a second length less than the first length, the exterior molding being fixedly molded around an entire circumference of the hydraulic hose in spaced relation from opposing ends of the hydraulic hose,
wherein the exterior molding includes a contiguous plurality of different hose control sections, each said hose control section having:
a plurality of spaced-apart rings that extend in a length direction of the exterior molding, the plurality of rings including a first end ring and a second end ring at opposing ends of the hose control section and at least one middle ring between the first and second end rings, and
at least two spannings each running continuously from the first end ring to the second end ring of the hose control section,
wherein the at least two spannings are spaced from each other radially, according to different radii extending from a central axis of the exterior molding, and
wherein the hose control sections are configured to restrict movement and/or bend of respective underlying portions of the hydraulic hose according to one or more predefined directions based on configuration of the plurality of rings and the at least two spannings.

2. The hydraulic hose assembly according to claim 1, wherein for at least one of the hose control sections the at least two spannings consist of two of said spannings, said two spannings being radially spaced relative to each other by 180 degrees.

3. The hydraulic hose assembly according to claim 1, wherein for at least one of the hose control sections the at least two spannings consist of four of said spannings, said four spannings being radially spaced relative to each other by 90 degrees.

4. The hydraulic hose assembly according to claim 1, wherein at least one of the hose control sections is curved.

5. The hydraulic hose assembly according to claim 4, wherein at least one of the hose control sections is straight.

6. The hydraulic hose assembly according to claim 1, wherein a maximum outer diameter of the exterior molding is uniform along the second length of the exterior molding.

7. The hydraulic hose assembly according to claim 1, wherein each of the hose control sections has a plurality openings defined by the plurality of rings and the at least two spannings.

8. The hydraulic hose assembly according to claim 7,
wherein the openings of a first one of the hose control sections are uniform,
wherein the openings of a second one of the hose control sections are uniform, and
wherein the openings of said first hose control section are different in configuration from the openings of said second hose control section.

9. A one-piece exterior molding for controlling routing of an underlying hose comprising:
a plurality of rings that extend in spaced relationship in a length direction of the exterior molding from a first end of the exterior molding to a second end of the exterior molding opposite the first end; and
at least two spannings each running in the length direction of the exterior molding from a first end portion of the exterior molding to a second end portion of the exterior molding opposite the first end portion, each of the at least two spannings being made up of a plurality of spanning portions between adjacent rings of the plurality of rings,
wherein the at least two spannings are spaced from each other radially, according to different radii extending from a central axis of the exterior molding, and
wherein the exterior molding is configured to control routing of the underlying hose according to straight and/or one or more curves based on configuration of the plurality of rings and the at least two spannings.

10. The one-piece exterior molding according to claim 9, wherein a maximum outer diameter of the exterior molding is uniform along a length of the exterior molding.

11. The one-piece exterior molding according to claim 9, wherein the radial spacing of the at least two spannings is by a factor of 90 degrees.

12. The one-piece exterior molding according to claim 9, wherein the plurality of rings and the at least two spannings define a plurality of openings in the exterior molding, each of the openings extending entirely through the exterior molding, from an outer surface of the exterior molding to an inner surface of the exterior molding.

13. The one-piece exterior molding according to claim 12,
wherein the plurality of openings include a first set of openings and a second set of openings,
wherein the first set of openings is separated from the second set of openings in the length direction of the exterior molding, and
wherein the first set of openings has a first geometrical configuration different from a second geometrical configuration of the second set of openings.

14. The one-piece exterior molding according to claim 9, wherein said at least two spannings consist of two of said spannings, said two spannings being radially spaced relative to each other by 180 degrees.

15. The one-piece exterior molding according to claim 9, wherein said at least two spannings consist of four of said spannings, said four spannings being radially spaced relative to each other by 90 degrees.

16. A method comprising:
providing a hose having a first length; and
providing a one-piece exterior molding having a second length less than the first length,
wherein the exterior molding includes:
a plurality of spaced-apart rings that extend along the second length of the exterior molding, and
at least two spannings each running continuously from a first end portion of the exterior molding to a second end portion of the exterior molding opposite the first end portion,
wherein the at least two spannings are spaced from each other radially, according to different radii extending from a central axis of the exterior molding, and
wherein the exterior molding is configured to control routing of the hose according to straight and/or one or more predefined curves based on configuration of the plurality of rings and the at least two spannings.

17. The method according to claim 16, wherein the exterior molding is fixedly overmolded to the hose so as to circumscribe an outer circumference of the hose.

18. The method according to claim 17, wherein the hose without the exterior molding has a first geometrical arrangement and a second geometrical arrangement different from the first geometrical arrangement when the exterior molding is fixedly overmolded to the hose.

19. The method according to claim 16, further comprising:
restricting movement and/or bending of the hose using the exterior molding based on the configuration of the plurality of rings and the at least two spannings according to a predetermined routing of the hose on a working machine.

20. The method according to claim 19, wherein said restricting movement and/or bending of the hose includes maintaining a first hose section straight using a first hose control section of the exterior molding and maintaining a second hose section according to a predefined curvature using a second hose control section different from the first hose control section.
